(19) United States
(12) Patent Application Publication
(10) Pub. No.: US 2011/0173519 A1
(43) Pub. Date: Jul. 14, 2011

(54) WIRELESS COMMUNICATION APPARATUS AND ERROR DETECTION RESULT FEEDBACK METHOD

(75) Inventors: Kenichi Kuri, Kanagawa (JP); Yuichi Kobayakawa, Osaka (JP); Katsuhiko Hiramatsu, Kanagawa (JP); Seigo Nakao, Kanagawa (JP); Ayako Horiuchi, Kanagawa (JP)

(73) Assignee: Panasonic Corporation, Osaka (JP)

(21) Appl. No.: 13/062,482

(22) PCT Filed: Sep. 11, 2009
(86) PCT No.: PCT/JP2009/004528

§ 371 Date: Mar. 4, 2011

(30) Foreign Application Priority Data
Sep. 12, 2008 (JP) 2008-235358

(51) Int. Cl. G06F 11/07; H04W 8/04

(52) U.S. Cl. 714/799; 714/E11.024

(57) ABSTRACT

A wireless communication apparatus and an error detection result feedback method wherein unnecessary retransmissions are avoided to improve the system throughput. At a base station (200), a decoding unit (205) decodes code words, which have been mapped to a TTI bundle, for the respective TTIs in the TTI bundle. An error detecting unit (206) detects errors in the decoding results. A control information generating unit (209) sequentially transmits, in accordance with detection timings, error detection result information related to the code word transmitted in the tail TTI in the TTI bundle, as well as error detection result information related to the code word transmitted in at least one of the other TTIs. In this way, an apparatus that transmits the code words can use the result of error detection in the tail TTI as a reference used for deciding the execution of a retransmission, so that unnecessary retransmissions can be avoided.

### TECHNICAL FIELD

The present invention relates to a radio communication apparatus and an error detection result feedback method.

### BACKGROUND ART

Third-generation mobile communication services have been launched, and multimedia communication such as data communication or video communication is increasingly popular. It is expected that demand for communication in all circumstances increases, and therefore coverage area is expanded in future.

Therefore, with 3GPP-LTE (Long Term Evolution), introduction of a technique referred to as “TTI-bundling” has been agreed in order to expand coverage for uplink transmission from terminals (UEs: User Equipments) to a base station (eNB enhanced Node B). With TTI-bundling, a UE residing near a cell edge bundles a plurality of TTIs in uplink transmission, and this is regarded as one HARQ process. Then, small data such as VoIP data is encoded with a low coding rate, a resultant codeword is mapped to a plurality of TTIs and transmitted to improve the uplink reception quality in a base station. Hereinafter, a plurality of bundled TTIs may be referred to as “TTI bundle.”

FIG. 1 explains a retransmission process in communication system adopting the TTI-bundling technique. FIG. 1 shows a case in which three TTIs are bundled.

In FIG. 1, a terminal bundles TTIs 0 to 2 to transmit data to a base station. Here, the terminal transmits a codeword mapped to at least TTI 0, adding CRC to the codeword. The base station receives and decodes this data. The base station performs error detection on only data transmitted in the first TTI using CRC check. Then, upon detecting an error, the base station transmits NACK to the terminal. Upon receiving the NACK, the terminal retransmits data in a retransmission-scheduled period.

Here, when TTIs are assigned to uplink data from the terminal at the first transmission, retransmission-scheduled periods are determined at this time. In FIG. 1, the retransmission-scheduled periods corresponding to TTIs 0 to 2 are TTIs 8 to 10. Therefore, the terminal performs retransmission in TTIs 8 to 10. Here, an interval (here, eight TTIs) between transmission-scheduled periods (including the first transmission period and a retransmission-scheduled period) is determined based on the round trip time of a HARQ process (HARQ-RTT) between a terminal residing near a cell edge and a base station. A HARQ-RTT is determined based on the time to propagate transmission signals (the first transmission signal and NACK) between a terminal and a base station, and the time to perform processing, including transmission signal generation processing, in the terminal and the base station.

### CITATION LIST

### Non-Patent Literature

NPL 1
R1-081103, RAN1, “Reply LS on Uplink Coverage for LTE,” 3GPP TSG RAN WG1 #52, Sorrento, Feb. 11-15, 2008

### SUMMARY OF INVENTION

### Technical Problem

However, the above-described conventional communication system has a problem that unnecessary retransmission is performed. That is, as shown in FIG. 2, a base station performs error detection on only data transmitted in the first TTI in a group of bundled TTIs, and transmits ACK/NACK to a terminal, based on this result of the detection. Therefore, even if an error is corrected in process of decoding subsequent TTIs in a group of bundled TTIs (that is, in a state in which ACK should be transmitted), when a base station has already transmitted NACK to a terminal, the terminal will perform retransmission processing. This causes a problem that the system throughput decreases.

In addition, as shown in FIG. 3, in a case in which a system that transmits ACK/NACK to a terminal, based on results by receiving and decoding up to the last TTI, it is possible to transmit only retransmission data for one TTI using only TTI 10, which is a retransmission-scheduled period, due to HARQ-RTT. This causes a problem that retransmission data quality received in a base station deteriorates.

It is therefore an object of the present invention to provide a radio communication apparatus and an error detection result feedback method to improve the system throughput by preventing unnecessary retransmission without deteriorating retransmission data quality.

### Solution to Problem

The radio communication apparatus according to the present invention that receives a radio signal in which a codeword obtained by encoding one transmission data is mapped to a TTI bundle composed of a plurality of TTIs adopts a configuration to include: a decoding section that decodes, per TTI, the codeword mapped to the TTI bundle; an error detecting section that performs error detection on each decoding result; and a transmission section that sequentially transmits error detection result information about the codeword transmitted in at least another TTI in the TTI bundle, in addition to error detection result information about the codeword transmitted in a last TTI.

The error detection result feedback method according to the present invention includes the steps of: receiving a radio signal in which a codeword obtained by encoding one transmission data is mapped to a TTI bundle composed of a plurality of TTIs; decoding, per TTI, the codeword mapped to the TTI bundle; performing error detection on each decoding result; and sequentially transmitting error detection result information about the codeword transmitted in at least another TTI in the TTI bundle, in addition to error detection result information about the codeword transmitted in a last TTI.

### Advantageous Effects of Invention

According to the present invention, it is possible to provide a radio communication apparatus and an error detection result feedback method to improve the system throughput by preventing unnecessary retransmission without deteriorating retransmission data quality.

### BRIEF DESCRIPTION OF DRAWINGS

FIG. 1 explains a retransmission process in a communication system adopting the TTI-bundling technique;

FIG. 2 explains a retransmission a process communication system adopting the TTI-bundling technique;

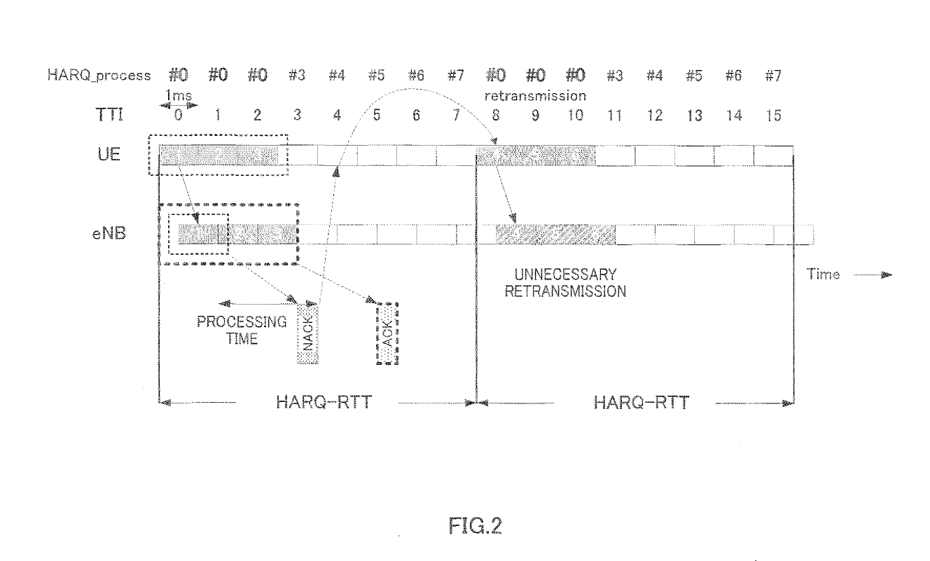

FIG. 3 explains related art.

FIG. 4 is a block diagram showing a configuration of a terminal according to Embodiment 1 of the present invention;

FIG. 5 is a block diagram showing a configuration of a base station according to Embodiment 1 of the present invention;

FIG. 6 explains operations of the terminal and the base station according to Embodiment 1 of the present invention;

FIG. 7 explains a state in which a codeword is stored in a circular buffer, and a method of reading the codeword from the circular buffer (at the time of the first transmission);

FIG. 8 explains operations of the terminal and the base station according to Embodiment 1 of the present invention;

FIG. 9 explains a state in which a codeword is stored in a circular buffer, and a method of reading the codeword from the circular buffer (at the time of retransmission);

FIG. 10 explains operations of a terminal and a base station according to Embodiment 2 of the present invention;

FIG. 11 explains operations of a terminal and a base station according to Embodiment 3 of the present invention; and

FIG. 12 explains operations of the terminal and the base station according to Embodiment 3 of the present invention.

### DESCRIPTION OF EMBODIMENTS

Now, embodiments of the present invention will be described in detail with reference to the accompanying drawings. Here, in the embodiments, the same components are assigned the same reference numerals and overlapping descriptions will be omitted.

[The Configuration of a Terminal]

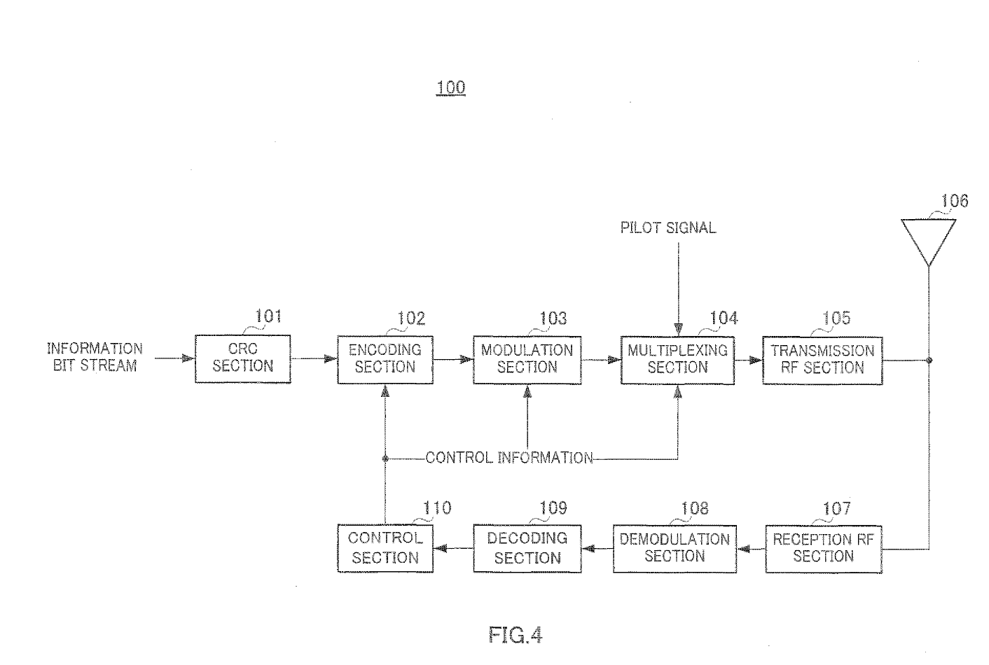

FIG. 4 is a block diagram showing the configuration of terminal 100 according to Embodiment 1 of the present invention. In FIG. 4, terminal 100 has CRC section 101, encoding section 102, modulation section 103, multiplexing section 104, transmission RF section 105, antenna 106, reception RE section 107, demodulation section 108, decoding section 109 and control section 110.

CRC section 101 performs error detection (CRC: cyclic redundancy check) and coding on an information bit stream, and outputs a resultant information bit stream to which CRC parity bits have been added, to encoding section 102.

Encoding section 102 has a circular buffer (not shown).

Encoding section 102 performs turbo coding on the information bit stream with CRC parity bits, with a mother coding rate and stores a resultant codeword in the circular buffer. Encoding section 102 extracts an output codeword matching control information received from control section 110, from codewords stored in the circular buffer, and outputs it to modulation section 103. The control information received from control section 110 includes transmission type information (including a coding rate) indicating transmission by TTI-bundling, a new transmission command, a retransmission preparation command, a retransmission execution command, M-ary modulation number information, or assigned frequency resource information.

At the time of new (the first) transmission, encoding section 102 extracts an output codeword matching the coding rate contained in control information received from control section 110, from codewords stored in the circular buffer, and outputs it to modulation section 103. Encoding section 102 performs processing associated with preparation for retransmission, retransmission and transmission of new data (including processing to delete the codeword for the data transmitted last time from the circular buffer), based on control information received from control section 110. Processing in encoding section 102 will be described in detail later.

Modulation section 103 generates a data symbol by modulating the codeword received from encoding section 102 with the M-ary modulation number contained in the control signal received from control section 110, and outputs the resultant data symbol to multiplexing section 104.

Multiplexing section 104 multiplexes the data symbol received from modulation section 103, the control information received from control section 110 and a pilot signal, and forms a multiplexed signal, which is a baseband signal. At this time, the data symbol is placed in the assigned frequency indicated by assigned frequency resource information contained in the control information received from control section 110.

Transmission RF section 105 transforms the multiplexed signal to a frequency domain signal, and transmits a resultant RF signal via antenna 106.

Reception RF section 107 receives a control signal (including assignment information or an ACK/NACK signal) transmitted from base station 200 (described later), via antenna 106, and transforms a received signal to a frequency domain signal to obtain a baseband signal. This baseband signal is outputted to demodulation section 108.

Demodulation section 108 demodulates a control signal contained in the baseband signal received from reception RF section 107, and outputs a demodulated control signal to decoding section 109.

Decoding section 109 decodes the demodulated control signal, and outputs resultant control information to control section 110.

Control section 110 specifies a coding rate, an M-ary modulation number, assigned frequency resources and ACK/NACK information contained in the control information received from decoding section 109. In addition, control section 110 determines whether or not to perform processing, including preparation for retransmission, decision to perform retransmission, retransmission and transmission of new data, based on the specified ACK/NACK information, and outputs control information according to the result of the determination to encoding section 102. In addition, among the specified control information, the coding rate is outputted to encoding section 102, the M-ary modulation number is outputted to modulation section 103, and the assigned frequency resources are outputted to multiplexing section 104.

[The Configuration of a Base Station]

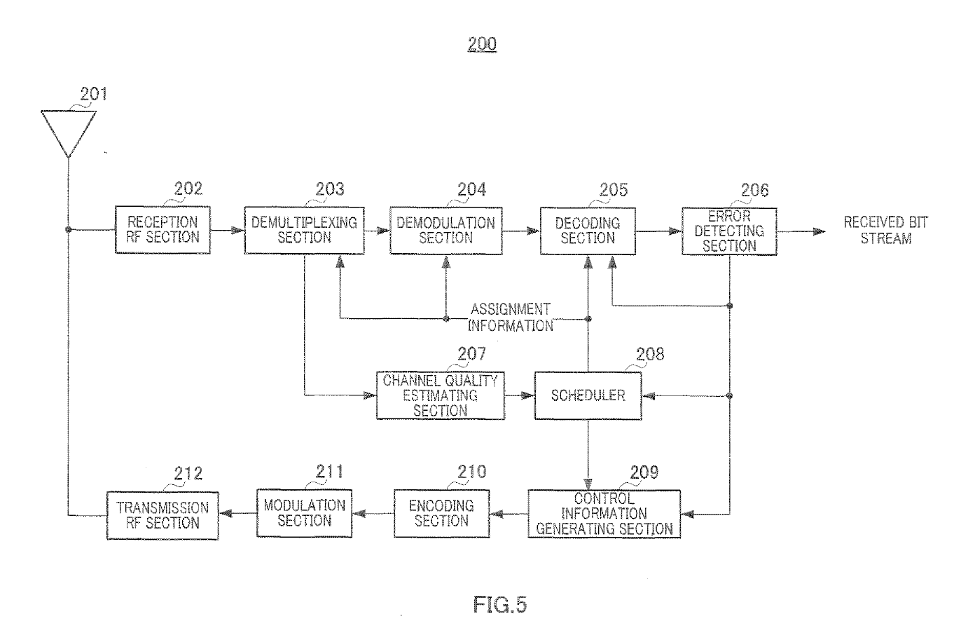

FIG. 5 is a block diagram showing the configuration of base station 200 according to Embodiment 1 of the present invention. In FIG. 5, base station 200 has antenna 201, reception RF section 202, demultiplexing section 203, demodulation section 204, decoding section 205, error detecting section 206, channel quality estimating section 207, scheduler 208, control information generating section 209, encoding section 210, modulation section 211, and transmission RF section 212.

Reception RF section 202 receives a data signal transmitted from terminal 100 via antenna 201, and transforms the received data signal to a frequency domain signal to obtain a baseband signal. This baseband signal is outputted to demultiplexing section 203.

Demultiplexing section 203 demultiplexes the baseband signal received from reception RF section 202 into a data symbol and a received pilot signal. Moreover, demultiplexing section 203 outputs a data symbol matching assigned frequency resource information contained in assignment information received from scheduler 208, to demodulation section 204, and outputs the received pilot signal to channel quality estimating section 207.

Demodulation section 204 demodulates the data symbol received from demodulation section 203, according to M-ary modulation number information contained in the assignment information received from scheduler 208.

Decoding section 205 performs error correction decoding per TTI on the result of the demodulation received from demodulation section 204, based on coding rate information contained in the assignment information received from scheduler 208 to obtain a decoded bit stream. This obtained decoded bit stream (received data) is stored in a memory (not shown) provided in decoding section 205, and is outputted to error detecting section 206. The result of this decoding in the ITT in a TTI bundle is used to decode the codeword transmitted in the next TTI. Therefore, in a TTI bundle, the error rate of a codeword transmitted in a later TTI is lower. In addition, only when receiving an ACK signal from error detecting section 206, decoding section 205 discards received data having already been stored in a memory.

Error detecting section 206 performs error detection (CRC) per TTI on the decoded bit stream received from decoding section 205.

When there is an error in the decoded bit stream as a result of error detection, error detecting section 206 generates a NACK signal as a response signal, and, on the other hand, when there is no error in the decoded bit stream, generates an ACK signal as a response signal. This generated ACK/NACK signal is outputted to decoding section 205, scheduler 208 and control information generating section 209. In addition, when there is no error in the decoded bit stream, error detecting section 206 outputs the decoded bit stream as a received bit stream.

Channel quality estimating section 207 estimates channel quality (SINR: signal-to-interference and noise power ratio) from the received pilot signal. The SINR estimation value is outputted to scheduler 208.

Scheduler 208 generates assignment information, based on the SINR estimation value received from channel quality estimating section 207 and the ACK/NACK signal received from error detecting section 206. This assignment information includes M-ary modulation number information, coding rate information and assigned resource information. This assignment information is outputted to control information generating section 209, demultiplexing section 203, demodulation section 204 and decoding section 205. Scheduling of retransmission data in scheduler 208 will be described later.

Control information generating section 209 receives an ACK/NACK signal from error detecting section 206. Then, when data transmission is performed using the TTI-bundling technique, control information generating section 209 transmits an ACK/NACK signal for the codeword transmitted in a plurality of TTIs in a TTI bundle, according to the detecting timings. Here, control information generating section 209 sequentially transmits an ACK/NACK signal for the codeword transmitted in at least another TTI in a TTI bundle, in addition to an ACK/NACK signal for the codeword transmitted in the last TTI, according to the detecting timings. Control information generating section 209 generates a control signal frame by combining an ACK/NACK signal and assignment information received from scheduler 208, and transmits this frame via encoding section 210, modulation section 211 and transmission RF section 212.

The control signal frame generated in control information generating section 209 is encoded in encoding section 210, modulated in modulation section 211, transformed to a frequency domain signal in transmission RF section 212, and then transmitted via antenna 201.

[Descriptions of Operations of Terminal 100 and Base Station 200]

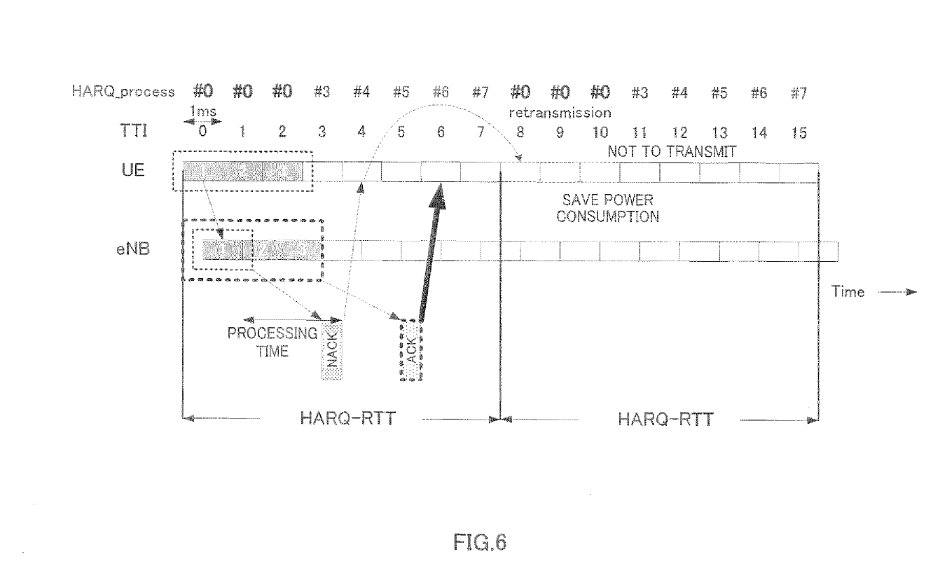

FIG. 6 explains operations of terminal 100 and base station 200. Now, referring to FIG. 6, operations of terminal 100 and base station 200 will be explained.

(The First Transmission by Terminal 100)

As shown in FIG. 6, terminal 100 bundles TTIs 0 to 2 to transmit data. That is, in terminal 100, encoding section 102 extracts an output codeword matching the coding rate contained in control information received from control section 110, from codewords stored in a circular buffer, and outputs it to modulation section 103.

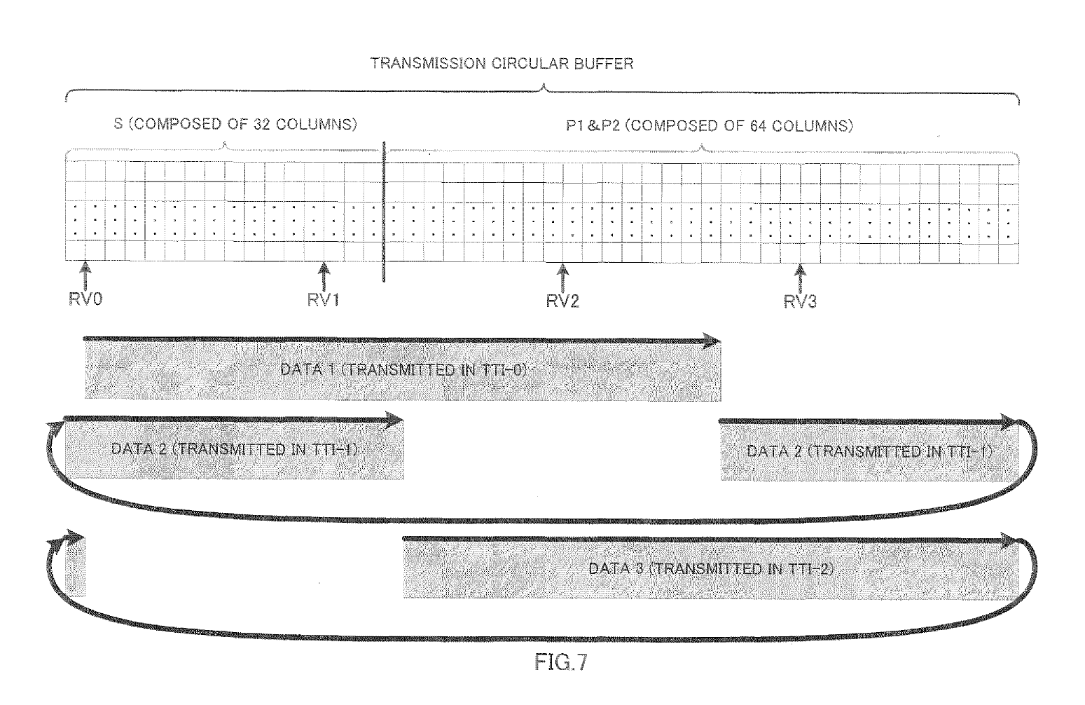

FIG. 7 explains a case in which a codeword is stored in a circular buffer, and a method of reading the codeword from the circular buffer (at the time of the first transmission).

As shown in FIG. 7, the circular buffer is composed of ninety-six columns and stores a codeword. S (composed of thirty-two columns) in the left part is formed with information bits to which CRC parity bits have been added (that is, systematic bits), and P1 and P2 (composed of sixty-four columns) in the right part is formed with parity bits generated by turbo coding. Here, the systematic bit side is defined as the front, and the parity bit side is defined as the back.

Encoding section 102 reads the codeword of a predetermined length from a predetermined reading start position toward the back, as data 1 transmitted in TTI 0, and outputs the codeword to modulation section 103. Here, the predetermined reading start position (RV 0) is the third column from the left in the circular buffer (FIG. 7). In addition, the predetermined length corresponds to sixty-four columns in the circular buffer. Therefore, data 1 is equivalent to part of the circular buffer from the third column to the sixty-sixth column.

Next, encoding section 102 also reads the codeword of a predetermined length (equivalent to data 2 in FIG. 7) from the column following the last column read in data 1, as a reading start position, toward the back, and outputs it to demodulation section 103. Here, when the last column is arrived at in the circular buffer before completion of reading of the codeword of a predetermined length, reading is continued from the first column in the circular buffer. Therefore, data 2 is equivalent to the part from the sixty-seventh column to the ninety-sixth column and the part from the first column to the thirty-fourth column in the circular buffer.

Next, encoding section 102 also reads the codeword of a predetermined length (equivalent to data 3 in FIG. 7) from the column following the last column read in data 2, as a reading start position, toward the back, and outputs it to demodulation section 103. Data 3 is equivalent to the part from the thirty-fifth column to the ninety-sixth column and the part from the first column to the second column in the circular buffer. Here, RV (redundancy version) is command information to specify the position in the circular buffer from which a codeword is read. 3GPP LTE defines that RV 0 corresponds to the third column, RV 1 corresponds to the twenty-seventh column, RV 2 corresponds to the fifty-first column and RV 3 corresponds to seventy-fifth column. Then, RV 0 is used at the time of the first transmission.

As described above, as shown in FIG. 6, a plurality of codewords read from a circular buffer are transmitted in a TTI bundle composed of TTIs 0 to 2, and received in base station 200 and relay station 300.

(ACK/NACK Signal Transmission in Base Station 200)

In base station 200, error detecting section 206 performs error detection on received data per TTI.

Then, control information generating section 209 transmits the result of the error detection (i.e. an ACK/NACK signal) for the codeword transmitted in at least another TTI in a TTI bundle, in addition to the result of the error detection for the codeword transmitted in the last TTI, according to the detecting timings. Here, an ACK/NACK signal for the codeword transmitted in TTI 0, which is the first TTI, in addition to an ACK/NACK signal for the codeword transmitted in TTI 2, which is the last TTI.

(Scheduling of Retransmission Data From Terminal 100, in Base Station 200)

As described later, in terminal 100, an ACK/NACK signal transmitted in the first TTI is used as a trigger for preparation for retransmission, and an ACK/NACK signal transmitted in the last TTI is used as a criterion for decision to perform retransmission. That is, as described later, only when NACK signals are transmitted in both the first TTI and the last TTI, terminal 100 performs retransmission. Therefore, only when NACK signals are transmitted in both the first TTI and the last TTI, scheduler 208 in base station 200 secures resources for retransmission using a TTI bundle from terminal 100 (that is, for example, frequency resources for retransmission-scheduled periods TTI 8 to TTI 10).

(Processing Associated with Preparation for Retransmission and Decision to Perform Retransmission in Terminal 100)

Terminal 100 determines whether or not to start preparing for retransmission of the entire TTI bundle, based on an ACK/NACK signal for TTI 0, which is transmitted from base station 200, and determines whether or not to perform retransmission of the prepared codeword for the entire TTI bundle, based on an ACK/NACK signal for TTI 2.

To be more specific, in terminal 100, control section 110 determines whether or not to command encoding section 102 to start preparation for retransmission of the entire TTI bundle, based on an ACK/NACK signal for TTI 0. Then, when base station 200 transmits a NACK signal for TTI 0, control section 110 commands encoding section 102 to start preparation for retransmission in the entire TTI bundle. On the other hand, when base station 200 transmits an ACK signal for TTI 0, control section 110 commands encoding section 102 to prepare for transmission of new data.

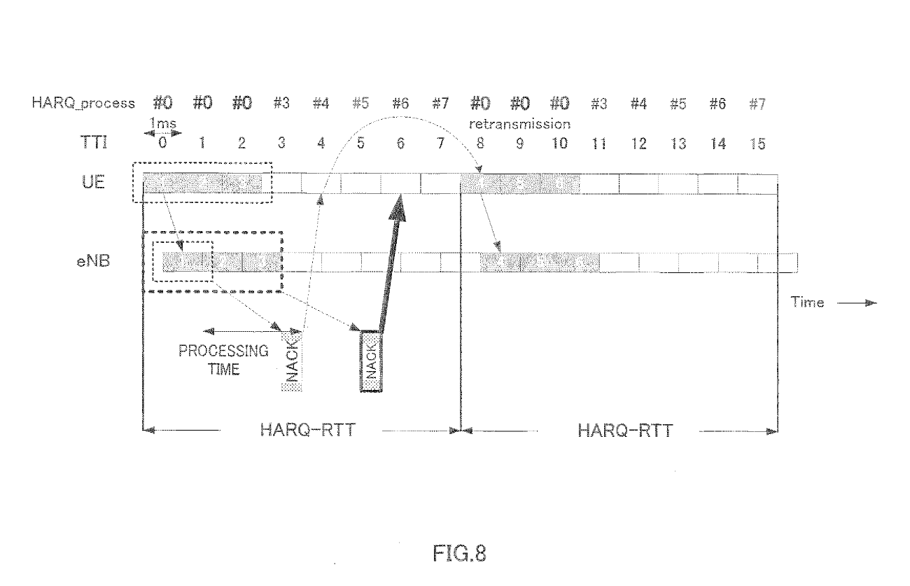

In addition, in terminal 100, control section 110 determines whether or not to command to encoding section 102 to retransmit the prepared codeword for the entire TTI bundle, based on an ACK/NACK signal for TTI 2. Then, when base station 200 transmits an ACK signal for TTI 2, control section 110 does not command encoding section 102 to retransmit the prepared codeword for the entire TTI bundle. On the other hand, when base station 200 transmits a NACK signal for TTI 2, control section 110 commands encoding section 102 to retransmit the prepared codeword for the entire TTI bundle (see FIG. 8).

(Retransmission from Terminal 100)

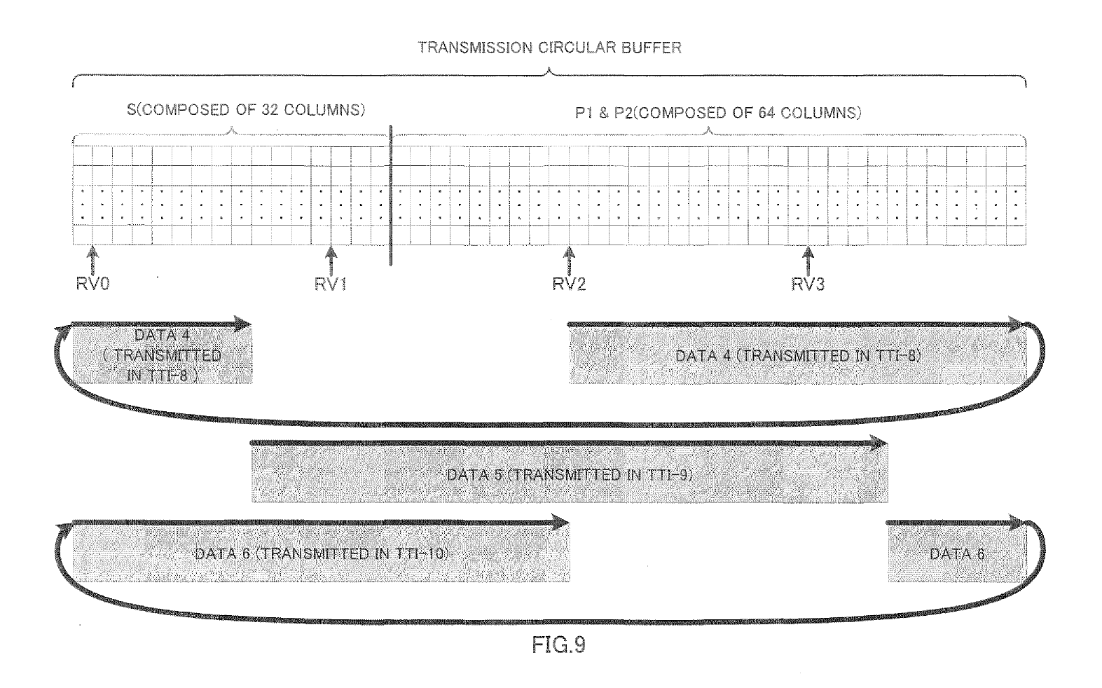

FIG. 9 explains a state in which a codeword is stored in a circular buffer, and a method of reading the codeword from a circular buffer (at the time of retransmission).

At the time of retransmission, encoding section 102 reads a codeword from a different position from the position at the time of last transmission, as a start position, extracts the codeword, and outputs it to modulation section 103. In FIG. 9, RV 2 is the reading start position at the time of the first retransmission.

As described above, according to the present embodiment, in base station 200, decoding section 205 decodes, per TTI, a codeword mapped to a TTI bundle, error detecting section 206 performs error detection on each decoding result, and control information generating section 209 sequentially transmits error detection result information for the codeword transmitted in at least another TTI in a TTI bundle, in addition to error detection result information for the codeword transmitted in the last TTI, according to the detecting timings.

By this means, terminal 100 can use the result of the error detection in the last TTI as a criterion for decision to perform retransmission, so that it is possible to prevent unnecessary retransmission such that retransmission data for a TTI bundle is transmitted in response to a NACK signal only for the first TTI as in the prior art.

[Comparative Technique]

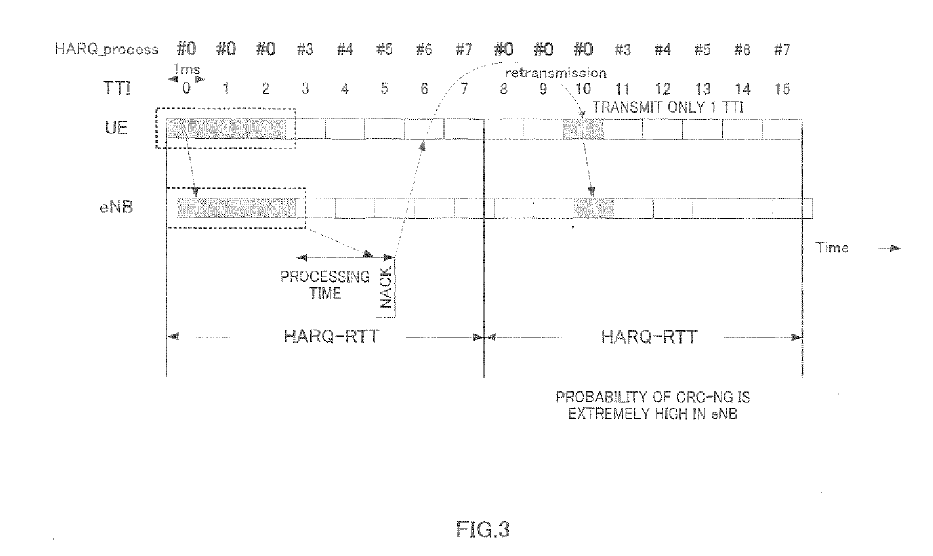

Here, an aspect is possible where base station 200 transmits the result of the error detection about the codeword transmitted in the last TTI in a TTI bundle, to terminal 100 (see FIG. 3). By this means, it is possible to prevent unnecessary retransmission. However, with this aspect, terminal 100 can perform retransmission only in the retransmission-scheduled period corresponding to the last TTI at the time of retransmission. That is, terminal 100 cannot perform retransmission using a TTI bundle. Because, even if preparation for retransmission in the retransmission-scheduled period corresponding to TTIs other than the last TTI starts after receiving a NACK signal in the last TTI, it is too late for retransmission in this retransmission-scheduled period. Therefore, it is not possible to perform retransmission using the TTI-bundling technique, so that error characteristics deteriorate in the data receiving side.

By contrast with this, according to the present embodiment, base station 200 sequentially transmits error detection result information about the codeword transmitted in at least another TTI in a TTI bundle, in addition to error detection result information about the codeword transmitted in the last TTI.

By this means, terminal 100 can use the result of error detection in every TTI other than the last TTI, as a trigger for starting preparing for retransmission, so that it is possible to perform retransmission using a TTI bundle. That is, according to the present embodiment, it is possible to realize base station 200 that improves error characteristics at the time of retransmission while preventing unnecessary retransmission.

In addition, the above-described another TTI is preferably the first TTI. This allows retransmission using the entire TTI bundle, like at the time of last transmission. Here, when another TTI is other than the first TTI, retransmission is performed from another TTI to the last TTI.

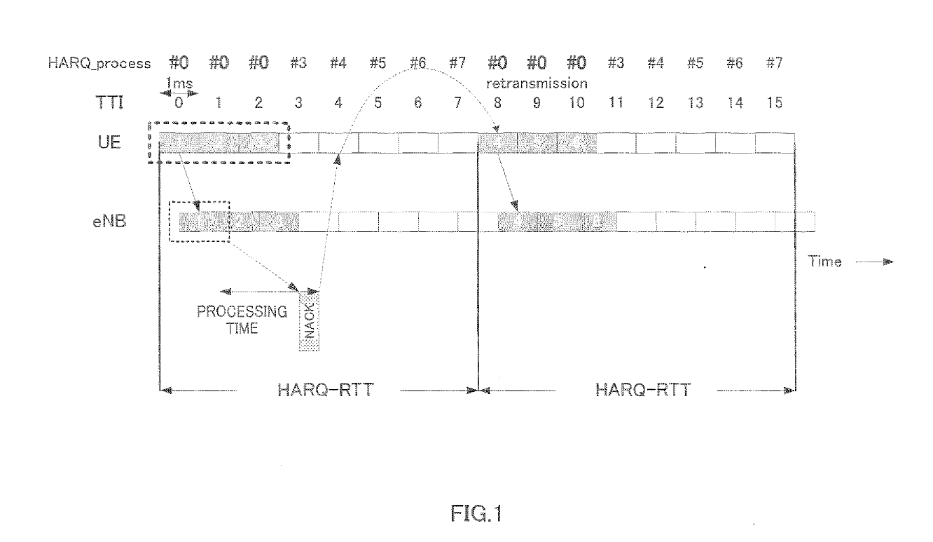

Here, in the above descriptions, a case has been explained where the result of the error detection for the codeword transmitted in the last TTI is always transmitted. However, even if the result of the error detection in the last TTI is not used, it is possible to reduce the probability of performing unnecessary retransmission, as compared to the prior art described in FIG. 1. The important thing is that, base station 200 may transmit the results of the error detection for the codeword transmitted in at least the first TTI and the second TTI in a TTI bundle. By this means, terminal 100 can use the result of the error detection in the first TTI transmitted earlier, as a trigger for starting preparing for retransmission, and use the result of the error detection in the second TTI as a criterion for decision to perform retransmission.

### Embodiment 2

With Embodiment 2, a base station transmits all the results of error detection about a codeword mapped to a TTI bundle. The basic configurations of a terminal and a base station according to the present embodiment are the same as those of the terminal and the base station described in Embodiment 1. Therefore, the terminal and the base station according to the present embodiment will be explained, with reference to FIG. 4 and FIG. 5. Here, operations of control section 110 in terminal 100, and scheduler 208 and control information generating section 209 in base station 200 vary from those in Embodiment 1.

In terminal 100 according to Embodiment 2, like in Embodiment 1, control section 110 determines whether or not to perform processing, including preparation for retransmission, decision to perform retransmission, retransmission and transmission of new data, based on specified ACK/NACK information, and outputs control information according to the result of the determination, to encoding section 102.

Here, with Embodiment 2, base station 200 transmits all the obtained results of error detection about a codeword mapped to a TTI bundle. Accordingly, although Embodiment 2 is the same as Embodiment 1 in that the result of the error detection in the first TTI is used as a trigger for starting preparing retransmission and the result of the error detection in the last TTI is used as a criterion for decision to perform retransmission, Embodiment 2 is different from Embodiment 1 in that the TTI between the first and last TTIs is used as a trigger for stopping preparing retransmission.

That is, when base station 200 transmits a NACK signal in the first TTI, control section 110 commands encoding section 102 to start preparing retransmission of the entire TTI bundle.

Then, if base station 200 transmits an ACK signal for the TTI other than the first TTI and the last TTI in a TTI bundle, control section 110 commands encoding section 102 to stop preparing for retransmission having already been started at this time, and to prepare for transmission of new data.

In addition, in base station 200 according to Embodiment 2, control information generating section 209 sequentially transmit an ACK/NACK signal for the codeword transmitted in each TTI, according to the detecting timing. Scheduler 208 releases resources for retransmission in a TTI bundle at the time to transmit an ACK signal in that TTI bundle.

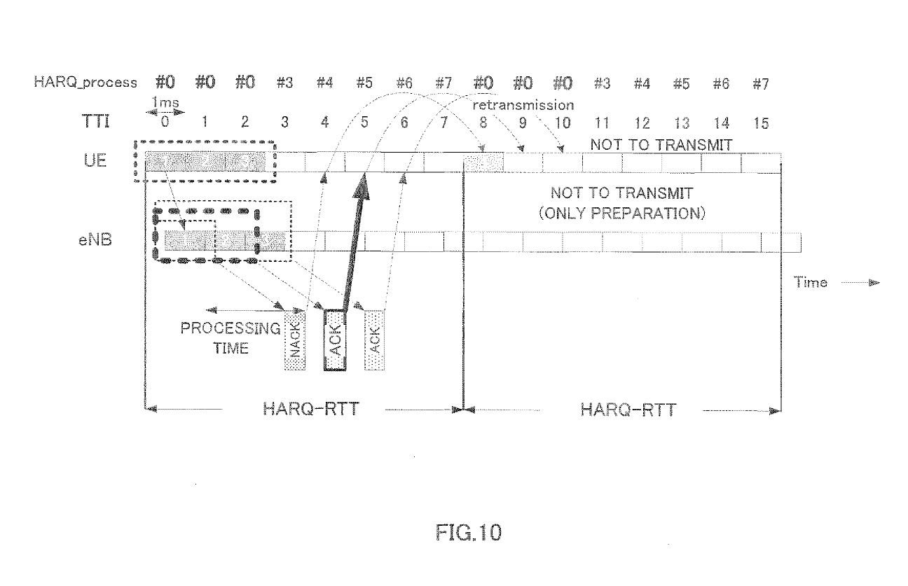

FIG. 10 explains operations of terminal 100 and base station 200 according to Embodiment 2.

As shown in FIG. 10, terminal 100 bundles TTIs 0 to 2 to transmit data to a base station.

In base station 200, error detecting section 206 performs error detection on received data per TTI. Then, control information generating section 209 sequentially transmits the result of the error detection in each TTI, according to the detecting timing. In FIG. 10, a NACK signal is transmitted in TTI 0 and an ACK signal is transmitted in TTI 2.

In terminal 100, control section 110 commands encoding section 102 to start preparing for retransmission of the entire TTI bundle because relay station 300 has transmitted a NACK signal for TTI 0.

Then, control section 110 commands encoding section 102 to stop preparing for retransmission having already been started and to prepare for transmission of new data because base station 200 has transmitted an ACK signal for TTI 1.

By this means, terminal 100 can stop preparing for retransmission at the time of receipt of an ACK signal without needing to wait for an ACK/NACK signal for the last TTI transmitted from base station 200, and therefore can reduce power consumption for preparation for retransmission. In addition, it is possible to start preparing for transmission of new data at the time of receipt of an ACK signal, so that it is possible to release a buffer area secured to retransmit data in an early stage.

### Embodiment 3

With Embodiment 3, a base station transmits an ACK/NACK signal only in the last TTI in a TTI bundle. Then, after transmitting data using a TTI bundle, a terminal automatically enters preparation for retransmission, and determines whether or not to perform retransmission, based on an ACK/NACK signal for the last TTI. The basic configurations of a terminal and a base station according to the present embodiment are the same as those of the terminal and the base station described in Embodiment 1. Therefore, the terminal and the base station according to the present embodiment will be explained, with reference to FIG. 4 and FIG. 5. Here, operations of control section 110 in terminal 100, and scheduler 208 and control information generating section 209 in base station 200 vary from those in Embodiment 1.

In terminal 100 according to Embodiment 3, like in Embodiment 1, control section 110 determines whether or not to perform processing, including decision to perform retransmission, retransmission and transmission of new data, based on specified ACK/NACK information, and outputs control information according to the result of the determination, to encoding section 102. Here, regarding preparation for retransmission, control section 110 transmits data using a TTI bundle, and then commands encoding section 102 to start preparing for retransmission. Then, control section 110 determines whether or not to perform retransmission, based on the result of the error detection in the last TTI transmitted from base station 200.

In addition, in base station 200 according to Embodiment 3, control information generating section 209 transmits only an ACK/NACK for the codeword transmitted in the last TTI in a TTI bundle. Only when an ACK signal is transmitted in the last TTI, scheduler 208 releases resources for retransmission in this TTI bundle.

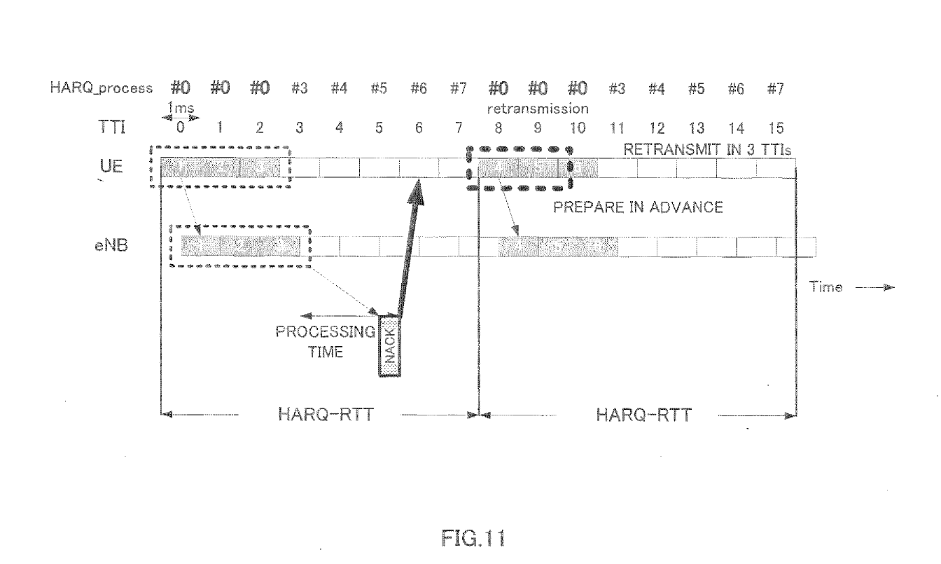

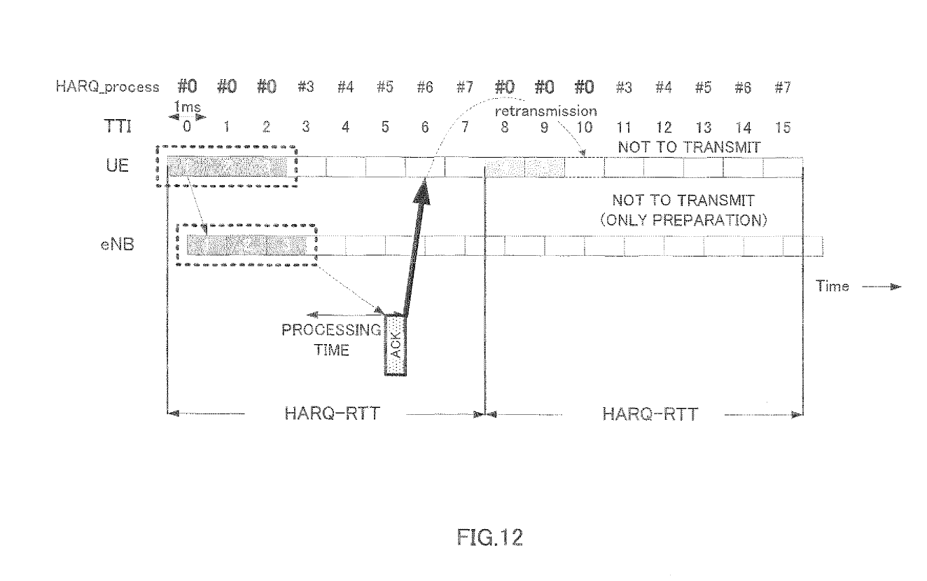

FIG. 11 and FIG. 12 explain operations of terminal 100 and base station 200 according to Embodiment 3.

As shown in FIG. 11, terminal 100 bundles TTIs 0 to 2 to transmit data. At this time, in terminal 100, control section 110 commands encoding section 102 to start preparing for retransmission in the entire TTI bundle.

In base station 200, error detecting section 206 performs error detection on received data per TTI. Then, control information generating section 209 transmits only the result of the error detection in the last TTI, to terminal 100.

Then, terminal 100 determines whether or not to perform retransmission, based on the result of the error detection in the last TTI transmitted from base station 200. In FIG. 11, control section 110 commands encoding section 102 to perform retransmission in the entire TTI bundle because base station 200 has transmitted NACK signals. On the other hand, when base station 200 transmits an ACK signal, control section 110 commands encoding section 102 to prepare for transmission of new data.

By this means, it is possible to improve error characteristics at the time of retransmission while preventing unnecessary retransmission, and it is possible to reduce the number of times of transmissions of ACK/NACK signals to 1 in one TTI bundle.

### Another Embodiment

(1) With Embodiment 3, base station 200 transmits only an ACK/NACK signal for the codeword transmitted in the last TTI, to terminal 100. However, if another embodiment is adopted where base station 200 transmits an ACK/HACK signal for only a TTI in which no error is detected for the first time in a TTI bundle, instead of the last TTI, it is possible to produce the same effect as in Embodiment 3.

In this embodiment, control information generating section 209 transmits an ACK/NACK signal for only a TTI in which no error is detected for the first time in one TTI bundle, to terminal 100. Terminal 100 uses this ACK/NACK signal as a criterion for decision to perform retransmission, like in Embodiment 3.

By this means, terminal 100 can receive an ACK signal in an earlier stage than in Embodiment 3, and therefore can stop preparing for retransmission at an early stage. Therefore, it is possible to reduce power consumption for preparation for retransmission. In addition, terminal 100 can start preparing for transmission of new data at the time of receipt of an ACK signal, so that it is possible to release a buffer area secured for retransmission data in an early stage.

(2) Here, although, with Embodiment 1, a case has been explained where a predetermined length read from a circular buffer is sixty-four columns, a predetermined length varies depending on the amount of resources assigned by base station 200. In addition, a case has been explained where the column numbers of RVs, which are the positions to read in a circular buffer, are that RV 0 is the third column, RV 1 is the twenty-seventh column, RV 2 is the fifty-first column and RV 3 is the seventy-fifth column, respectively, they may be derived according to other relational equations.

(3) Here, with Embodiments 1 to 3, although cases have been explained where decoding and error detection are performed per TTI, processing to perform decoding and error detection only at the timing to transmit an ACK/NACK signal, is possible.

(4) Here, with Embodiments 1 to 3, although cases have been explained where a TTI bundle is composed of three TTIs, a TTI bundle may be composed of two or more TTIs.

(5) With Embodiments 1 to 3, although descriptions have been explained by assuming an FDD (frequency division duplex) system using varying frequencies between the uplink and downlink, the present invention is not limited to this and is practicable in a TDD (time division duplex) system.

(6) Also, although cases have been described with Embodiments 1 to 3 as examples where the present invention is configured by hardware, the present invention can also be realized by software.

Each function block employed in the description of each of Embodiments 1 to 3 may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2008-235358, filed on Sep. 12, 2008, including the specification, drawings and abstract, is incorporated herein by reference in its entirety.

### INDUSTRIAL APPLICABILITY

The radio communication apparatus and the error detection result feedback method according to the present invention are useful for improvement of the system throughput by preventing unnecessary retransmission without deteriorating retransmission data quality.

1. A radio communication apparatus that receives a radio signal in which a codeword obtained by encoding one transmission data is mapped to a transmission time interval (TTI) bundle composed of a plurality of TTIs, the radio communication apparatus comprising:
a decoding section that decodes, per TTI, the codeword mapped into the TTI bundle;
an error detecting section that detects error of each decoding result; and
a transmission section that sequentially transmits information on the error detection result of the codeword transmitted in at least another TTI in the TTI bundle, in addition to information on the error detection result of the codeword transmitted at a last TTI.

2. The radio communication apparatus according to claim 1, wherein another TTI is every TTI other than the last TTI in the TTI bundle.

3. The radio communication apparatus according to claim 1, wherein another TTI is a beginning TTI in the TTI bundle.

4. An error detection result feedback method comprising the steps of:
receiving a radio signal in which a codeword obtained by encoding one transmission data is mapped to a TTI bundle composed of a plurality of TTIs;
decoding, per TTI, the codeword mapped to the TTI bundle;
performing error detection on each decoding result; and sequentially transmitting information on the error detection result of the codeword transmitted in at least another TTI in the TTI bundle, in addition to information on the error detection result of the codeword transmitted at a last TTI.
